(19) United States
(12) Patent Application Publication
(10) Pub. No.: US 2006/0291462 A1
(43) Pub. Date: Dec. 28, 2006

(54) Method and apparatus using multiple application cards to comprise multiple logical network entities

(75) Inventors: Arun C. Alex, Bartlett, IL (US); Kunnath Sudhir, Bolingbrook, IL (US); Abhishek Sharma, Streamwood, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/169,088

(22) Filed: Jun. 28, 2005

(51) Int. Cl. H04L 12/56; H04L 12/66

(52) U.S. Cl. 370/389; 370/463

(57) ABSTRACT

An apparatus (301) is comprised of a plurality of application cards (302-304) wherein at least a plurality of the application cards each comprise a part, but not all, of a plurality of logical network entities (307 and 308) such as a Packet Data Serving Node. A data packet session manager (305) can serve to manage the allocation and/or usage of one or more session resources (309) by these application cards. In a preferred approach the external interfaces (310) of these application cards are also aggregated and used, in cluster fashion, by each of the logical network entities.

### RELATED APPLICATIONS

This application relates to the following patent applications as were filed on even date herewith (wherein the contents of such patent applications are incorporated herein by this reference):

SYSTEM AND METHOD FOR PERFORMING A DISTRIBUTED CONFIGURATION ACROSS DEVICES (attorney's docket number 85233); and

PACKET DATA ROUTER APPARATUS AND METHOD (attorney's docket number 85235).

### TECHNICAL FIELD

This invention relates generally to packet data-based communications and more particularly to network entities such as Packet Data Serving Nodes, Home Agents, and the like.

### BACKGROUND

Packet data communication networks are well known in the art. Such networks typically comprise a plurality of various kinds of network entities such as, but not limited to, Packet Data Serving Nodes (PDSNs), Home Agents, and so forth. In general, a one-to-one physical correspondence often exists as between a given network entity and its enabling platform. For example, a Packet Data Serving Node application instance will typically be installed on a single packet data communication system application card (as may be installed, for example, in a chassis that provides power and necessary or useful interfaces to the application card). As another example, a plurality of Home Agent instances may be supported by a single application card.

When such an application card fails for whatever reason, the session service associated with that network entity is usually lost until that application card returns to service or a substitute application card becomes active. In the event of the former scenario the session service may be lost for an indeterminate period of time. Even in the case of the latter a switchover may consume around half a minute or more. In either case the desired service remains unavailable for some period of time that constitutes an unacceptable duration to at least some system administrators and users.

In some cases it may be possible to improve upon such latency by providing more aggressive hot standby capability. Such an approach, however, often leads to a considerable increase in expense and network resource utilization to ensure the constant updating of the backup platform (or platforms).

### BRIEF DESCRIPTION OF THE DRAWINGS

The above needs are at least partially met through provision of the method and apparatus using multiple application cards to comprise multiple logical network entities described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an apparatus can comprise a plurality of packet data communication system application cards wherein each of at least a plurality of the plurality of packet data communication system application cards comprise a part, but not all, of a first single logical network entity having a first single Internet Protocol (IP) address and a part, but not all, of a second single logical network entity having a second single Internet Protocol address that is different from the first Internet Protocol address. In a preferred approach this apparatus further comprises a data packet session manager that is operably coupled to the plurality of packet data communication system application cards and that is configured and arranged to manage at least one packet data session resource as is shared by each packet data communication system application card as comprise, in the aggregate, the first single logical network entity.

The supported logical entities can comprise, for example, Packet Data Serving Nodes, Home Agents, and so forth. Pursuant to one approach, the data packet session manager can comprise a packet switch card as resides in a commonly shared chassis with the application cards. The shared session resource can vary with the needs and requirements of a given application but might comprise, for example, IP addresses and/or other network element identifiers.

In a preferred approach the application cards each further comprise at least one packet data external interface. The packet data external interfaces for each of the application cards as comprise the first logical network entity are grouped as a first logical interface cluster and correlated with a first single Internet Protocol address. Similarly, the packet data external interfaces for each of the application cards as comprise the second logical network entity are also grouped as a second logical interface cluster and correlated with a second single Internet Protocol address. So configured, the various application cards as comprise a single logical network entity effectively see and share the various network interfaces as are available to any of the application cards as comprise that logical network entity.

So configured, those skilled in the art will appreciate that the functionality as characterizes a given network entity (such as a PDSN or a Home Agent) is distributed over a plurality of application cards (and also that many (or all) of these application cards each supports more than one such network entity). Accordingly, a failure of any given application card does not result in the automatic loss of a specific session service capability. Instead, only some capacity to provide that service becomes reduced. Though still comprising a circumstance that may warrant attention and repair, this approach tends to greatly mitigate against the kinds of (short or long term) delay and complete loss of service as tends to be associated with various prior art approaches.

Furthermore, these teachings are deployable in a relatively technically and economically acceptable manner. These teachings make no requirement for significant provision of redundant resources. Furthermore, even communication updates as may be useful to maintain current information across these application cards tend to be less burdensome than many other previously suggested approaches.

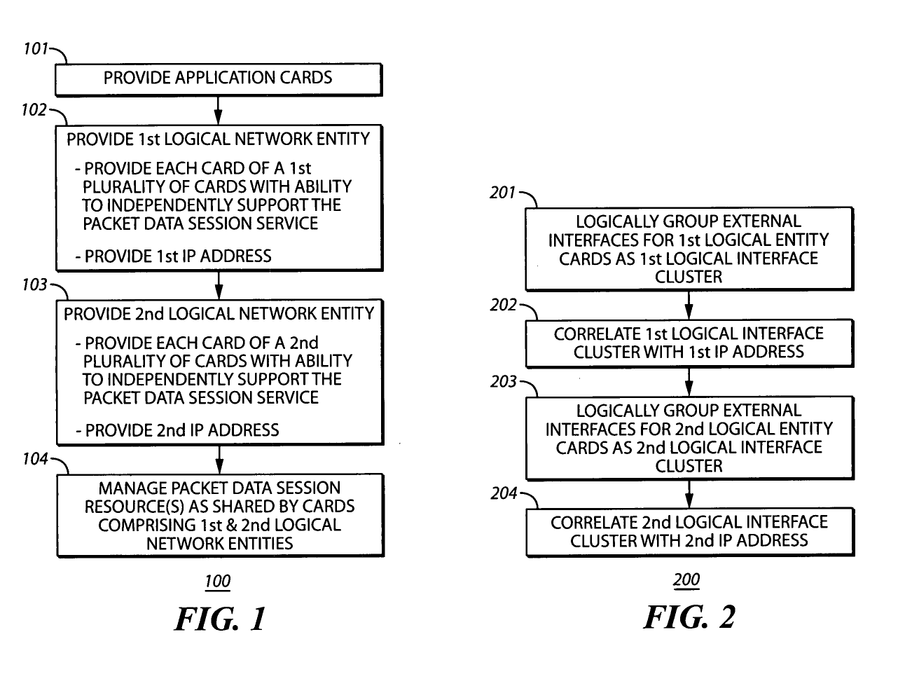

These and other benefits may become clearer upon making a thorough review and study of the following detailed description. Referring now to the drawings, and in particular to FIG. 1, an illustrative process 100 provides for provision 101 of a plurality of packet data communication system application cards (also sometimes known in the art as “blades”) (such as, but not limited to, Application GateWay (AGW) cards as are available through UTStarcom). As used herein, “application card” shall be understood to refer to a class of network entity platforms that are typically themselves without a housing and that are designed and intended to be inserted into a rack-style chassis, where that chassis is itself typically designed to receive a plurality of such application cards and which has a backplane to provide power to and interconnections between such application cards along with network and control connections to other components and network entities which may, or may not, be also resident within that chassis.

Such application cards are typically at least partially programmable and those skilled in the art will understand that such application cards are readily programmable to comport with the teachings set forth herein. The precise number of application cards so provided can and will vary with the needs of a given setting with four or five cards being a likely sufficient quantity for many useful purposes such as provisioning a network entity such as a Packet Data Serving Node (PDSN), a Home Agent (HA), or the like.

As will be disclosed below, it will also be preferred to further provide a data packet session manager. This data packet session manager can comprise, for example, a Packet Switch Card as is known in the art and which also preferably (though not necessarily) shares the same chassis as receives (at least some of) the above noted application cards. The purpose of such a data packet session manager will be made clearer below.

This process 100 then provides for provision 102 of a first logical network entity and provision 103 of a second logical network entity. (Those skilled in the art will understand and recognize that additional logical network entities may also be provided in accordance with these teachings and that these approaches are, indeed, highly scalable in this regard. For the sake of clarity, however, only two such logical network entities are specifically discussed here.) As used herein, it will be understand that the term “logical” refers to the fact that these network entities are not physically integral and distinct onto themselves; instead, these network entities are distributed over multiple platforms (i.e., the aforementioned application cards and data packet session manager) as will now be described.

To form the first logical network entity, a first plurality of the packet data communication system application cards are each provided with an ability to support a first type of packet data session service independently of each other. The first type of packet data session service can comprise, for example, a Packet Data Serving Node type of packet data session service, a Home Agent type of packet data session service, and so forth.

As a more specific example, then, when the first logical network entity comprises a Packet Data Serving Node, this first plurality of application cards are each able to independently provide PDSN service regardless of the presence, or absence, of others of their own kind. So configured, the ability of this logical network entity to provide the indicated type of service is not impaired when a given one of the application cards becomes unavailable aside from experiencing a reduction in capacity to provide that service. Similarly, adding additional such cards does not then necessarily imbue this logical network entity with additional types of service (though it could); instead, such additional cards generally serve to increase the capacity of the logical network entity to provide that first type of service (i.e., the number of sessions that can be simultaneously supported by, in this example, a PDSN).

Provision 102 of this first logical network entity also comprises providing a first Internet Protocol (IP) address. More particularly, in a preferred approach, this first Internet Protocol address comprises the network identifier for the first logical network entity itself such that an external network element can potentially interface with any of this first plurality of application cards by using this first Internet Protocol address. In other words, and again in keeping with the distributed nature of these embodiments, external network elements will typically remain generally ignorant regarding the distributed nature of the first logical network entity and will instead address them in an aggregated manner. The data packet session manager can, if desired, provide a mechanism for directing internal activities amongst these various packet data communication system application cards.

The above-mentioned second logical network entity (which preferably provides the same type of packet data session service as the first logical network entity) is configured in substantially a similar manner as that just described for the first logical network entity. Importantly, however, it should be noted that at least some of the packet data communication system application cards as comprise, in the aggregate, the second logical network entity also comprise the first logical network entity.

To illustrate, four separate packet data communication system application cards may be provided and each used to support both the first and second logical network entities, where both logical network entities comprise independent and discrete Packet Data Serving Nodes that each have a corresponding independent and distinct network address. In such a configuration, none of the application cards serves, in its entirety, to enable only one of the logical network entities.

To put it another way, pursuant to these teachings, a plurality of application cards are each used to comprise a plurality of discrete logical network entities that provide a same kind of session service (such as PDSN services, Home Agent services, and so forth). So configured, the capacity of each network entity is readily scalable to meet system needs and loading. In addition, the loss of any given application card for whatever reason and regardless of the duration of that loss will not remove the network entity itself from service as only the capacity of that network entity is impacted by such a loss. Instead, the network entity remains capable of continuing to render its defining services albeit with diminished capacity. It will also be understood that these benefits occur without (or in addition to) any redundancy as may be available through standby application cards or the like.

This process 100 then also provides for managing 104 at least one packet data session resource as is shared by each packet data communication system application card as comprise, in the aggregate, these logical network entities. This can comprise, for example, managing a pool of allocable Internet Protocol addresses, a pool of request identifiers, at least one User Datagram Protocol (UDP) port identifier, and so forth as are known in the art. This management can comprise, for example, distributing and parsing such resources amongst the various packet data communication system application cards as comprise the first and second logical network entities.

These teachings are flexible and will work compatibly with a variety of additional capabilities. As one example, this process can further provide for detecting when a given one of the application cards fails (using any of a variety of presently known or likely hereafter-developed techniques) and maintaining a corresponding record of packet data communication system application card states that reflect such condition or events. This record, in turn, can be taken into account and used when managing one or more packet data session resources as is (or are) shared amongst the packet data communication system application cards as comprise these logical entities. As one simple example, resources as were allocated to a given application card can be withdrawn and redistributed upon determining that this given application card now exhibits a failed state of operation.

Those skilled in the art will recognize that packet data communication system application cards typically have one or more (often two) external physical interfaces (for example, Ethernet interfaces). Pursuant to these teachings it may be desirable in many application settings to effectively group those external interfaces in a logical aggregation. A corresponding process 200 as is illustrated in FIG. 2 will now be described.

Presuming again that each packet data communication system application card has at least one packet data external interface, this process 200 provides for logically grouping 201 the packet data external interfaces for each of the first plurality of packet data communication system application cards as comprise the first logical network entity as a first logical interface cluster. To illustrate, when the first logical network entity comprises four packet data communication system application cards, and where each application card has two Ethernet ports, those eight (total) Ethernet ports are logically aggregated to comprise this first logical interface cluster. So aggregated, the aforementioned first Internet Protocol address as is provided for the first logical network entity is then correlated 202 with this first logical interface cluster.

In a similar fashion the external interfaces for the application cards that comprise the second logical network entity are also logically grouped 203 to form a second logical interface cluster which is, in turn, correlated 204 with the second Internet Protocol address as corresponds to the second logical network entity. Since these teachings provide for a sharing of application cards by a plurality of network entities, it will be understood that the external interfaces for those application cards will also be distributed over and shared by a plurality of logical interface clusters.

To illustrate, when there are two logical network entities that are each comprised of a shared set of four application cards, and where each application card has two external interfaces, that total of eight external interfaces will serve both as a first logical interface cluster having a first Internet Protocol address for the first logical network entity and as a second logical interface cluster having a second Internet protocol address for the second logical network entity. As these same application cards support additional logical network entities, these same external interfaces can and preferably will additionally serve as parts of the logical interface clusters as are associated with those additional network entities.

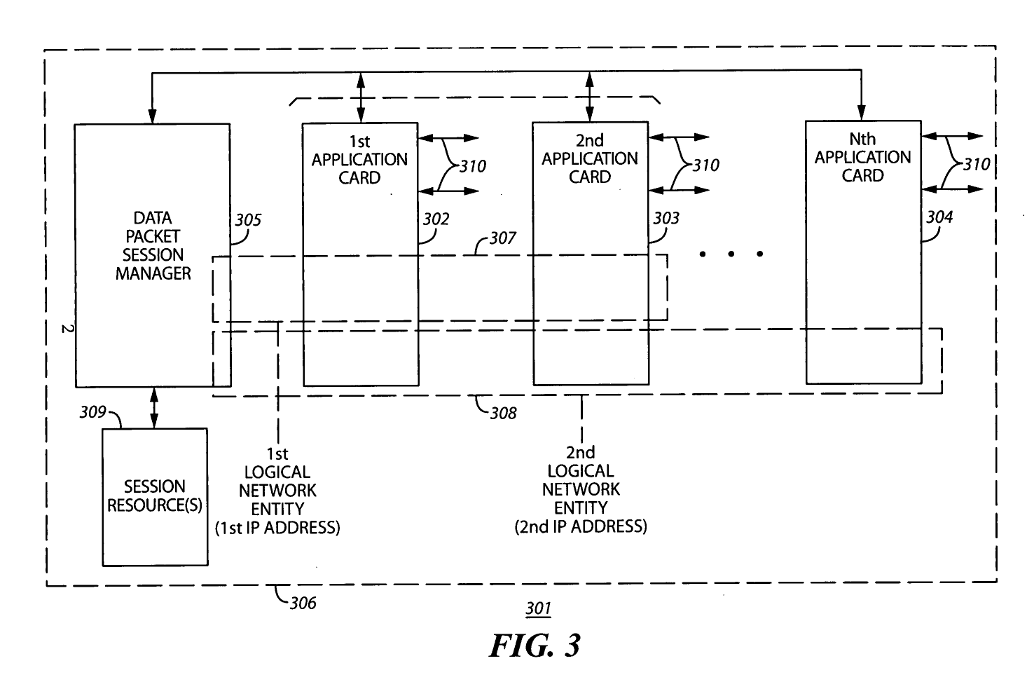

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

This apparatus 301 comprises, in this embodiment, a rack-based chassis having slots (not shown) that receive first through Nth application cards 302-304 and a data packet session manager 305 comprising a Packet Switch Card. These components couple to, draw power from, and interact via a backplane 306. The above components and their cooperative interaction is generally understood in the art and requires no further elaboration here aside to note that the application cards and the data packet session manager are further programmed and configured to function in accord with the teachings set forth above.

In this illustrative embodiment a first logical network entity 307 (comprising, for example, a PDSN or a Home Agent) is comprised of a portion of the data packet session manager 305 and portions of the first and second application cards 302 and 303. In accordance with these teachings this first logical network entity 307 has a first Internet Protocol address by which an external network entity can interact therewith. In this embodiment a second logical network entity 308 is comprised of a portion of the first through the Nth application cards 302-304 and a portion of the data packet session manager 305. It can therefore be seen that at least some of the application cards (i.e., the first and second application cards 302 and 303) each comprise an independent part of both the first and the second logical network entity 307 and 308.

So configured, the data packet session manager 305 is able to manage at least one session resource 309 as is shared by each packet data communication system application card as comprise, in the aggregate, these logical network entities. This can comprise, for example, allocating one or more session resources for individual use by individual application cards if desired.

In a preferred embodiment, as already noted above, it may also be desirable to aggregate the external interfaces for each of the application cards. In this illustrative example each of the application cards 302-304 has two such external interfaces 310 and, as per the teachings set forth above, these external interfaces are grouped as appropriate to form corresponding logical interface clusters that are shared by each application card as comprises a part of a given logical network entity. For example, in this illustration, the external interfaces 310 for the first and second application cards 302 and 303 can be grouped to form a logical interface cluster for the first logical network entity 307 and the external interfaces 310 for the first through the Nth application cards 302-304 can be grouped to form a logical interface cluster for the second logical network entity 308. In a preferred approach these logical interface clusters are correlated to the Internet Protocol addresses as are provided to each of the logical network entities.

So configured, it can be seen that at least some of these application cards each comprise a part, but not all, of a first and a second data packet data session service facilitation logical platform (such as a PDSN or a Home Agent). In particular, each such application card is able to facilitate a shared type of packet data session service substantially independent of other application cards as comprise other parts of that logical platform. It will also be seen and understood that at least some of the external interfaces are each simultaneously used in conjunction with other external interfaces to support the interface requirements of one or more of the logical network entities.

Through application of these teachings a network entity can be provided that will not likely drop out of service simply because one of its constituent application cards drops out of service. Instead, at most, the throughput capacity of that network entity may be impaired. It will also be seen that these benefits can be obtained without requiring the equipment and informational backup requirements that tend to characterize a protection scheme that is based on redundancy. As a result, these teachings are deployable in a relatively cost effective manner and usually without requiring reprogramming of external elements and/or new communication protocols to support external element interactions.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus comprising:
a plurality of packet data communication system application cards wherein each of at least a plurality of the plurality of packet data communication system application cards comprises:
a part, but not all, of a first single logical network entity having a first single Internet Protocol address;
a part, but not all, of a second single logical network entity having a second single Internet Protocol address, wherein the second single Internet Protocol address is different from the first single Internet Protocol address;
a data packet session manager that is operably coupled to the plurality of packet data communication system application cards and that is configured and arranged to manage at least one packet data session resource as is shared by each packet data communication system application card as comprise, in the aggregate, the first single logical network entity.

2. The apparatus of claim 1 wherein the first single logical network entity comprises at least one of:
a Packet Data Serving Node;
a Home Agent.

3. The apparatus of claim 1 wherein the first single logical network entity and the second single logical network entity each comprise at least one of:
a Packet Data Serving Node;
a Home Agent.

4. The apparatus of claim 1 wherein the data packet session manager comprises a packet switch card.

5. The apparatus of claim 1 wherein the at least one packet data session resource comprises at least one of:
a pool of allocable Internet Protocol addresses;
a pool of Authentication, Authorization, and Accounting (AAA) request identifiers;
a pool of User Datagram Protocol port identifiers.

6. The apparatus of claim 1 wherein the data packet session manager comprises means for allocating the at least one packet data session resource for individual use by the packet data communication system application cards as comprise, in the aggregate, the first single logical network entity.

7. The apparatus of claim 1 wherein the data packet session manager is further arranged and configured to manage at least one packet data session resource as is shared by each packet data communication system application card as comprise, in the aggregate, the second single logical network entity.

8. An apparatus comprising:
a plurality of packet data communication system application cards;
first single logical network entity means having a first single Internet Protocol address and being comprised of a first plurality of the plurality of packet data communication system application cards for providing at least a first packet data session service using a packet data session resource via either of at least two of the first plurality of the plurality of packet data communication system application cards;
second single logical network entity means having a second single Internet Protocol address and being comprised of a second plurality of the plurality of packet data communication system application cards for providing at least a first packet data session service using a packet data session resource via either of at least two of the second plurality of the plurality of packet data communication system application cards, wherein:
the first plurality and the second plurality of packet data communication system application cards are at least partially coextensive;
the first single Internet Protocol address is different than the second single Internet Protocol address;
data packet session manager means that is operably coupled to the plurality of packet data communication system application cards for managing packet data session resources as are shared by each packet data communication system application card as comprise, in the aggregate, the first single logical network entity means and the second single logical network entity means.

9. The apparatus of claim 8 further comprising:
a chassis having a backplane, wherein the chassis receives the plurality of packet data communication system application cards and the data packet session manager means and the plurality of packet data communication system application cards and the data packet session manager means interact, at least in part, via the backplane.

10. The apparatus of claim 8 wherein the first packet data session service comprises at least one of:
a Packet Data Serving Node session service;
a Home Agent session service.

11. The apparatus of claim 8 wherein the packet data session resources as are managed by the data packet session manager means comprise at least one of:
a pool of allocable Internet Protocol addresses;
a pool of Authentication, Authorization, and Accounting (AAA) request identifiers;
a pool of User Datagram Protocol port identifiers.

12. A method of facilitating packet data communication sessions, comprising:
providing a plurality of packet data communication system application cards;
providing a first logical network entity, at least in part, by:
providing each of a first plurality of the plurality of packet data communication system application cards with an ability to support a first type of packet data session service independently of others of the first plurality of the plurality of packet data communication system application cards;
providing a first single Internet Protocol address such that an external network element can potentially interface with any of the first plurality of the plurality of packet data communication system application cards by using the first single Internet Protocol address;
providing a second logical network entity, at least in part, by:
providing each of a second plurality of the plurality of packet data communication system application cards with an ability to support the first type of packet data session service independently of others of the second plurality of the plurality of packet data communication system application cards, wherein the second plurality of the plurality of packet data communication system application cards includes at least one of the first plurality of the plurality of packet data communication system application cards;
providing a second single Internet Protocol address such that an external network element can potentially interface with any of the second plurality of the plurality of packet data communication system application cards by using the second single Internet Protocol address, wherein the second single Internet Protocol address is different from the first single Internet Protocol address;
managing at least one packet data session resource as is shared by each packet data communication system application card as comprise, in the aggregate, the first single logical network entity and the second single logical network entity.

13. The method of claim 12 wherein the first type of packet data session service comprises at least one of:
a Packet Data Serving Node type of packet data session service;
a Home Agent type of packet data session service.

14. The method of claim 12 wherein management at least one packet data session resource comprises managing at least one of:
a pool of allocable Internet Protocol addresses;
a pool of request identifiers;
a least one User Datagram Protocol port identifier.

15. The method of claim 12 further comprising:
detecting when a given one of the first plurality of the plurality of packet data communication system application cards fails;
and wherein managing at least one packet data session resource as is shared by each packet data communication system application card as comprise, in the aggregate, the first single logical network entity and the second single logical network entity further comprises:
maintaining a record of packet data communication system application card states that reflects this failed state of the given one of the first plurality of the plurality of packet data communication system application cards.

16. The method of claim 15 wherein managing at least one packet data session resource as is shared by each packet data communication system application card as comprise, in the aggregate, the first single logical network entity and the second single logical network entity further comprises:
using the record of packet data communication system application card states to manage the at least one packet data session resource.

17. The method of claim 12 wherein the packet data communication system application cards each comprise at least one packet data external interface, and wherein the method further comprises:
logically grouping the packet data external interfaces for each of the first plurality of the plurality of packet data communication system application cards as a first logical interface cluster;
and wherein providing a first single Internet Protocol address further comprises correlating the first single Internet Protocol address with the first logical interface cluster.

18. The method of claim 17 further comprising:
logically grouping the packet data external interfaces for each of the second plurality of the plurality of packet data communication system application cards as a second logical interface cluster;
and wherein providing a second single Internet Protocol address further comprises correlating the second single Internet Protocol address with the second logical interface cluster.

19. A packet data communication system application card comprising:
a part, but not all, of a first packet data session service facilitation logical platform, which part of the first packet data session service facilitation platform is able to facilitate a first type of packet data session service substantially independent of other packet data communication system application cards as comprise other parts of the first packet data session service facilitation logical platform;
a part, but not all, of a second packet data session service facilitation logical platform, which part of the second packet data session service facilitation platform is able to facilitate the first type of packet data session service substantially independent of other packet data communication system application cards as comprise other parts of the second packet data session service facilitation logical platform.

20. The packet data communication system application card of claim 19 wherein the first type of packet data session service comprises at least one of:
a Packet Data Serving Node packet data session service;
a Home Agent packet data session service.

21. The packet data communication system application card of claim 19 further comprising:
at least one packet data external interface;
and wherein the part of the first packet data session service facilitation logical platform uses the at least one packet data external interface in conjunction with an Internet Protocol address, wherein the Internet Protocol address is also simultaneously used in conjunction with at least one other packet data external interface as comprises a part of at least one other packet data communication system application card that comprises another part of the first packet data session service facilitation logical platform.
